(19) United States
(12) Patent Application Publication
(10) Pub. No.: US 2019/0106553 A1
(43) Pub. Date: Apr. 11, 2019

(54) ELASTOMER COMPOSITION INTENDED FOR EMBEDDING A COMPACT ANTENNA

(71) Applicant: KING KHALID UNIVERSITY (KKU), Abha (SA)

(72) Inventors: Abdullah G. AL-SEHEMI, Abha (SA); Ahmed A. AL-Ghamdi, Jeddah (SA); Nikolay Todorov Dishovsky, Sofia (BG); Nikolay Todorov Atanasov, Sofia (BG); Gabriela Lychezarova Atanasova, Sofia (BG)

(73) Assignee: KING KHALID UNIVERSITY (KKU), Abha (SA)

(21) Appl. No.: 15/819,273

(22) Filed: Nov. 21, 2017

(30) Foreign Application Priority Data
Oct. 6, 2017 (BG) 112593

(51) Int. Cl. C08L 7/00; B32B 25/04; B32B 25/12

(52) U.S. Cl. CPC C08L 7/00; B32B 25/042; B32B 2457/00; C08L 2203/20; C08L 2205/03; B32B 25/12

(57) ABSTRACT

The subject matter of the present patent application constitutes an elastomer composition intended for embedding a compact antenna designed to be used and operated in close proximity with regard to the human body to build short-range wireless communication links.

The elastomer composition for embedding a compact antenna is based on natural rubber and components whose quantities are expressed in parts in wt per 100 parts by weight of natural rubber (phr), namely: sulfur—1 to 2 phr; phenyl-trichloromethylsulfenyl-benzene sulfonamide—0.1 to 0.5 phr; diphenylguanidine—from 0.3 to 0.8 phr; tertiary butyl-benzothiazolyl-sulfenamide—from 1 to 2 phr; dimethylbutyl-phenyl-p-phenylenediamine—1.5 phr; polymerized trimethyl dihydroquinoline—1.5 phr; stearic acid—2.0 phr; zinc oxide—3.0 phr; rapeseed oil—15 to 30 phr; bis (triethoxysilylpropyl) tetrasulfide-silane—from 0.1 to 4.0 phr; 3-thiocyanato-propyl-triethoxy silane—from 2.0 to 6.0 phr; carbon black—5.0 phr; optionally silicon dioxide—from 10 to 50.0 phr, microcrystalline cellulose—from 20.0 to 60.0 phr. The composition of the invention is multilayer.

The advantages that the composition intended for embedding a compact antenna provides are: high efficiency when the antenna is placed over or in close vicinity to a human body model or metal surface pattern, a low specific absorption rate SAR (intensity of absorbed radiation) with regard to a human body model when the antenna is placed over or in close proximity to a human body model.

### STATE OF THE ART

The present invention relates to elastomer composition intended for embedding a compact antenna designed to be used and operated in close proximity with regard to the human body to build short-range wireless communication links.

### BACKGROUND ART/PRIOR ART

The following patent documents are known with regard to the state of the art and they disclose elastomer compositions designed to build wireless communication means

Patent document US2010090905 (A1) provides a dielectric elastomer composition with flame-retardant property, which is used as a material for an antenna. The composition contains: metal hydroxide such as aluminum hydroxide powder, magnesium hydroxide powder, polybromodiphenyl ether and polybromobiphenyl for 100 parts by weight of an elastomer such as ethylene propylene rubber.

Patent document KR20100099420 A discloses a mobile phone antenna made of a polymeric composite material having the following composition: a thermosetting resin, a thermoplastic resin, a metallic powder with conductivity, carbon black and a ferrite powder mixed in a predetermined ratio.

The solution proposed by patent document JP2008303246 A comprises elastomer with high efficiency that can be used with regard to antennas with a high value of the real part of permittivity and low dielectric loss upon contact. The composition according to the invention includes natural or synthetic ethylene propylene rubber, pigment paste, consisting of dispersed ceramic material and a pigment.

The closest prior art is considered to be document named “A Flexible Planar Antenna on Multilayer Rubber Composite for Wearable Devices” Progress In Electromagnetics Research C, Vol. 75, 31-42, 2017 The composition according to the publication comprises/parts in wt per 100 parts in wt of rubber/acrylonitrile butadiene rubber—100 phr, zinc oxide—3 phr, stearic acid—2 phr, processing oil (10.0 phr), isopropyl-phenyl-p-phenylenediamine—(1.0 phr), N-tertiary-Butyl-2-benzothiazolylsulfenamide—(0.7 phr), sulfur (1.5 phr).

### TECHNICAL ESSENCE AND SUMMARY OF THE INVENTION

The object of the present inventions is to provide a composition based on natural rubber designed for embedding small-size, compact antennas, operating in close proximity or placed directly over the skin of the human model and to provide optimal antenna radiation efficiency, which almost in no way is influenced by the presence of the human body, as well as low specific absorption rate (SAR) with regard to the human body.

According to the invention elastomer composition has been designed for embedding a compact antenna causing low absorption rate which can be placed over different parts of or near a human body model to carry out short-range wireless communication links. The elastomer composition for embedding a compact antenna is multilayer and is represented by two or three-layer model.

The elastomer composition for embedding a compact antenna is based on natural rubber and components whose quantities are expressed in parts in wt per 100 parts by weight of natural rubber (phr), namely: sulfur—ranging from 1 to 2 phr; phenyl-trichloromethylsulfenyl-benzene sulfonamide—ranging from 0.1 to 0.5 phr; diphenylguanidine—from 0.3 to 0.8 phr; tertiary butyl-benzothiazolyl-sulfenamide—from 1 to 2 phr; dimethylbutyl-phenyl-p-phenylenediamine—1.5 phr; polymerized trimethyl dihydroquinoline—1.5 phr; stearic acid—2.0 phr; zinc oxide—3.0 phr; rapeseed oil—15 to 30 phr; bis (triethoxysilylpropyl) tetrasulfide-silane—from 0.1 to 4.0 phr; 3-thiocyanato-propyl-triethoxy silane—from 2.0 to 6.0 phr; carbon black—5.0 phr; optionally silicon dioxide—from 10 to 50.0 phr, microcrystalline cellulose—from 20.0 to 60.0 phr.

Silicon dioxide is synthetic or a rice husk based and is contained in the following amounts, synthetic silicon dioxide ranging from 10 to 50 phr or rice husks based silicon dioxide contained in amounts ranging from 10 to 50 phr or a mixture thereof in a ratio ranging from 1:5 to 5:1.

So far, with regard to the implementation of body-centric communications (for body centric communications) of a person with frequency range of 2.38-2.5 GHz (Industrial, Scientific and Medical) band no elastomer composition is known designed for embedding a compact antenna based on natural rubber containing silicon dioxide—synthetic or rice husk based, microcrystalline cellulose and rapeseed oil.

The elastomer composition designed for embedding a compact antenna according to the invention provides the following advantages:

It does not experience effects of human tissue loading due to the fact that it is known that the proximity of user's head or body to wireless device antenna results in detuning of the resonant frequency, input impedance variation, modification of the antenna radiation pattern, etc.;

It is highly effective when placed over or in close proximity to a human body model or in close vicinity to metal surface pattern.

It causes a low specific absorption rate SAR (intensity of absorbed radiation) with regard to a human body model when placed over or in close proximity to a human body model.

Appropriate for off-body (building a connection between a device placed over the skin of human body and an external device, in majority of the cases a router) and on-body (designed for creating a connection between two devices placed over the skin of human body) communications in the frequency range of 2.38-2.50 GHz.

The described advantages of the elastomer composition designed for embedding a compact antenna are described in detail in one of the preferred embodiments of the invention wherein the metallic elements of the antenna are embedded in a three-layer elastomer composition made of natural rubber based mixtures containing microcrystalline cellulose and rapeseed oil, rice husks silicon dioxide, compared to an antenna whose metal elements are embedded in a two- and three-layer composite based on butadiene-acrylonitrile rubber and metallic dipole antenna:
1. Does not experience effects of human tissue presence due to the fact that it is well known that the proximity of user's head or body to wireless device antenna results in detuning of the resonant frequency, input impedance variation, modification of the antenna radiation pattern, etc.;

In order to demonstrate the above-described advantage, the parameters and characteristics of the antenna are examined in free space and on a numerical, three-layer model of a human body consisting of a layer of skin, fat and muscle tissue layers. The results displayed in FIG. 1 demonstrate that the resonant frequency of the antenna in the free space is 2.377 GHz. The resonant frequency of the antenna when placed over a layer of skin included in the three-layer model is 2.377 GHz, i.e there is no difference when the antenna is operating in the free space. The ability to maintain the resonant frequency is mainly due to the presence of a reflector and Layer 3 of the composition that provides the antenna with a degree of shielding from the effects of the human body.

It is highly effective when placed over or in close vicinity to a human body model.

The efficiency of the antenna is barely influenced by the presence of a human body model as shown in Table 1. The results demonstrate that when an antenna having elastomer composition according to the invention MCC-2/Example 2 of the present invention referred to in “Embodiment of the invention”/is placed on a human body model, it demonstrated 26.26% (−5.81 dB) of a radiation efficiency, which is higher than that one of an NBR-1-composition-related antenna/Composition based on butadiene-acrylonitrile rubber known from the document referred to in the prior art “A Flexible Planar Antenna on Multilayer Rubber Composite for Wearable Devices. In the free space, antenna emitting efficiency with MCC-2 is 31.75% (−4.98 dB).

TABLE 1
Radiation efficiency of antennas whose metal elements are embedded
in rubber compositions placed in free space and on a skin layer of a
three-layer human body model at a frequency of 2.456 GHz

| | Antena efficiency | | Antena efficiency on a | |
|---|---|---|---|---|
| | in free space | | human body model | |
| An antenna whose metal | 31.75% | −4.98 dB | 26.26% | −5.81 dB |
| elements are embedded in a | | | | |
| three layer elastomer | | | | |
| composition (all layers are | | | | |
| MCC-2) | | | | |
| An antenna whose metal | 23.2% | −6.35 dB | 20.50% | −6.88 dB |
| elements are embedded in a | | | | |
| three layer composition (all | | | | |
| layers are NBR-1) | | | | |
| An antenna whose metal | 23.21% | −6.34 dB | 18.30% | −7.38 dB |
| elements are embedded in a | | | | |
| two layer composition (all | | | | |
| layers are NBR-1) | | | | |
| Standard dipole antenna | 100% | 0 dB | 1.98% | −17.03 dB |

In order to better demonstrate the performance of an antenna whose metal elements are embedded in an elastomer composition according to the invention, the MCC-2 antenna is placed on a skin layer of a three-layer human body model, being compared to the antenna efficiency whose metal elements are embedded in NBR-1 at four frequencies of the ISM frequency range. The results are presented in Table 2.

TABLE 2
Radiation efficiency of antennas whose metal elements are embedded
in a rubber composition placed on a skin layer of a three-layer
human body model at four frequencies of the ISM frequency range

| | Radiation efficiency of | | | |
|---|---|---|---|---|
| | antenna, whose metal | | Radiation efficiency of | |
| | elements are embedded in a | | antenna, whose metal | |
| | three-layer elastomer | | elements are embedded in a | |
| | composition (all of the | | three-layer composition (all | |
| | layers are MCC-2 based) | | layers are NBR-1 based) | |
| 2.40 GHz | 21.13% | −6.75 dB | 15.71% | −8.04 dB |
| 2.428 GHz | 24.11% | −6.00 dB | 18.78% | −7.26 dB |
| 2.456 GHz | 26.26% | −5.81 dB | 21.24% | −6.73 dB |
| 2.484 GHz | 27.50% | −5.61 dB | 23.21% | −6.34 dB |

The results presented can prove that, the antenna whose metal elements are embedded in the MCC-2 elastomer composition according to the invention shows higher efficiency than the antenna embedded in NBR-1 composition with regard to all frequencies of the ISM frequency range.

3. Produces a low SAR (intensity of absorbed radiation) in a human body model when placed over or in close vicinity to a human body model.

To demonstrate this advantage, a comparison of the SAR of three antennas (an antenna whose metal elements are embedded in a three-layer composition, an antenna whose metal elements are embedded in a two-layer composition and a dipole antenna) on a human body model is carried out. In addition to that, data are presented regarding the distribution of SAR on the surface (skin layer) of a human body model caused by an antenna whose metal elements are embedded in a three-layer composition.

TABLE 3
Intensity of specific absorption rate SAR (W/kg) when the antenna is
placed over a three-layer human body model at frequency of 2,456 GHz

| | Specific absorption rate (SAR) (W/kg) | |
|---|---|---|
| | | At 250 mW |
| | At 100 mW of power | of power received |
| | received in the antenna | in the antenna |
| An antenna whose metal | 0.1978 | 0.4946 |
| elements are embedded in a | | |
| three layer elastomer | | |
| composition (all layers are | | |
| MCC-2) | | |
| An antenna whose metal | 0.2280 | 0.5700 |
| elements are embedded in a | | |
| three layer composition (all | | |
| layers are NBR-1) | | |
| An antenna whose metal | 0.8640 | 2.1600 |
| elements are embedded in a | | |
| two layer composition (all | | |
| layers are NBR-1) | | |
| Standard dipole antenna | 14.557 | 36.3925 |

The presented results demonstrate that the maximum specific absorption rate (SAR) shows its smallest value with regard to an antenna whose metal elements are embedded in the three-layer elastomer composition according to invention MCC-2. Additional information regarding the advantages of the antenna embedded in a three-layer elastomer composition of the invention is revealed in FIG. 2

The results displayed in FIG. 2 show that the maximum values occur at the end of the antenna edges. The results underneath the antenna are considerably reduced, being from 10 to 100 times lower (ranging from 0.028 to 0.002 W/kg). This occurs because of the reflector and Layer 3 of the elastomer composition which are located and lie between the antenna and the human body model providing some degree of electromagnetic waves' shielding.

### DESCRIPTION OF DRAWINGS

FIG. 1 displays is a reflection coefficient module of the input of an antenna whose metal elements are embedded in a three-layer MCC-2 elastomer composition placed in the free space and on the surface of a three-layer human body model. The presented results are obtained by means of calculation with the finite-difference time domain (FDTD) method.

FIG. 2 displays the specific absorption rate (SAR) distribution in a three-layer human body model when the antenna is placed on the surface of the skin layer of a three-layer human body model.

FIG. 3a, FIG. 3b, FIG. 3c, FIG. 3d visualize the antenna configuration.

FIG. 3a visualizes a front view of the upper radiating element on the first elastomer layer.

FIG. 3b displays a lower radiating element placed on the second elastomer layer.

FIG. 3c visualizes a reflector.

FIG. 3d visualizes the structure of the antenna layers, wherein positions 1, 2, 3, 4, 5 and 6 indicate as follows: 1 constitutes a top radiating element, 2 constitutes the first elastomer layer, 3 constitutes the lower radiating element, 4 constitutes the second elastomer layer, 5 is a reflector and 6 constitutes the third elastomer layer.

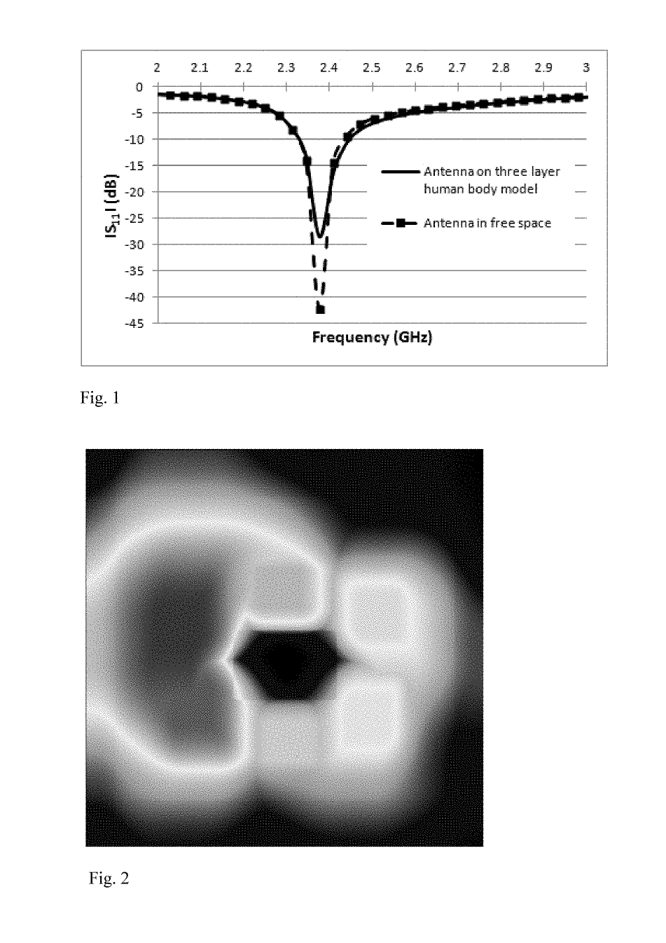

### PREFERRED EMBODIMENTS OF THE INVENTION

The present invention is illustrated by the following preferred embodiments represented by different compositions which are never intended to limit the invention scope.

### Example 1

In this example, a specific composition of the elastomer composition is represented which is used in two layers and the amounts of the components are expressed in parts per hundred weights of rubber, and are: sulfur—1.6 phr; phenyl-trichloromethyl-sulfenyl-benzenesulfonamide—0.3 phr; diphenylguanidine—0.5 phr; tertiary butyl-benzothiazolyl-sulfenamide—1.5 phr; dimethylbutyl-phenyl-p-phenylenediamine—1.5 phr; polymerized trimethyl dihydroquinoline—1.5 phr; stearic acid—2.0 phr; zinc oxide—3.0 phr; rapeseed oil—25.0 phr; 3-thiocyanato-propyl-triethoxy silane—from 2.0 phr to 6.0 phr, carbon black—5.0 phr; microcrystalline cellulose—60.0 phr; Bis(triethoxysilylpropyl)tetrasulfide (Si 69)—0.1 phr natural rubber—100 phr.

The rubber composite is prepared in an open laboratory two rolls mixing mill with roller dimensions L/D 320×160 mm, friction 1.7 and slower roller speed −25 min⁻¹. The vulcanization of the rubber composites was carried out on an electrically heated hydraulic press with plates with dimensions 400×400 mm at a temperature of 150° C., at 10 MPa and a time determined by the vulcanization isotherms of the composites taken on the MDR 2000 Rheometer manufactured by Alpha Technology.

The rubber compound is made in the manner described in Table 4.

TABLE 4
Methods for preparing rubber composite

| | | They are |
|---|---|---|
| : N | Elastomers and Ingredients | added at: |
| 1. | Natural rubber | 0 min. |
| 2. | Zinc oxide, stearic acid | 5 min. |
| 3. | Rapeseed oil, compatibles, fillers | 10 min. |
| 4. | Anti-aging agents - dimethylbutyl-phenyl-p- | 20 min. |
| | phenylenediamine, polymerized trimethyl | |
| | dihydroquinoline | |
| 5. | Accelerators - diphenylguanidine; tertiary butyl- | 25 min. |
| | benzothiazolyl-sulfenamide | |
| 6. | sulfur; phenyl-trichloromethylsulfenyl-benzene- | 27 min. |
| | sulfonamide | |
| 7. | Removal of the finished rubber compound from the roller | 30 min. |

### Example 2

The specific values of the elements contained in the elastomer composition which is used for the purposes of the three-layer option are expressed in wt per 100 parts by weight of rubber (phr), namely: sulfur—1.6 phr; phenyl-trichloromethyl-sulfenyl-benzenesulfonamide—0.3 phr; diphenylguanidine—0.5 phr; tertiary butyl-benzothiazolyl-sulfenamide—1.5 phr; dimethylbutyl-phenyl-p-phenylenediamine—1.5 phr; polymerized trimethyl dihydroquinoline—1.5 phr; stearic acid—2.0 phr; zinc oxide—3.0 phr; rapeseed oil—25.0 phr; Bis(triethoxysilylpropyl)tetrasulfide (Si 69)—3.0 phr; 3-thiocyanato-propyl-triethoxy silane/Si-264/—3.0 phr, carbon black N 550—5.0 phr; rice husks based silicon dioxide—30.0 phr, microcrystalline cellulose—30.0 phr; natural rubber—100 phr. The composition has laboratory-grade MCC-2.

The rubber compound is prepared according to the technology manner and conditions described in Example 1.

### Example 3

The third specific composition related to the elastomer composition is inclusive of the following weight parts, namely: sulfur—1.6 phr; phenyl-trichloromethyl-sulfenyl-benzenesulfonamide—0.3 phr; diphenylguanidine—0.5 phr; tertiary butyl-benzothiazolyl-sulfenamide—1.5 phr; dimethylbutyl-phenyl-p-phenylenediamine—1.5 phr; polymerized trimethyl dihydroquinoline/anti-aging agent/—1.5 phr; stearic acid—2.0 phr; zinc oxide—3.0 phr; rapeseed oil—25.0 phr; Bis(triethoxysilylpropyl)tetrasulfide silane (Si 69)—4.0 phr; 3-thiocyanato-propyl-triethoxy silane/Si-264/—2.0 phr, carbon black—5.0 phr; silicon dioxide/Ultrasil 7000 GR/—40.0 phr, microcrystalline cellulose—20.0 phr; natural rubber—100 phr.

The rubber compound is prepared according to the technology manner and conditions described in Example 1.

### Example 4

In this example, a specific composition of the elastomer composition is represented and the values of the components are expressed in wt parts per hundred weights of rubber, and are: sulfur—1.6 phr; phenyl-trichloromethyl-sulfenyl-benzene-sulfonamide—0.3 phr; diphenylguanidine—0.5 phr; tertiary butyl-benzothiazolyl-sulfenamide—1.5 phr; dimethylbutyl-phenyl-p-phenylenediamine—1.5 phr; polymerized trimethyl dihydroquinoline—1.5 phr; stearic acid—2.0 phr; zinc oxide—3.0 phr; rapeseed oil—25.0 phr; 3-thiocyanato-propyl-triethoxy silane—6.0 phr, carbon black—5.0 phr; microcrystalline cellulose—60.0 phr; natural rubber—100 phr

Table 5 lists quantitative values of ingredients of exemplary compositions according to the invention at 100 ppmv. natural rubber.

TABLE 5

| Ingredients | Example-5 | Example-6 |
|---|---|---|
| 1. Natural Rubber/STR-10/ | 100 | 100 |
| 2. Microcrystalline cellulose | 60 | 30 |
| 3. Rice husks based silicon dioxide | 50 | 15 |
| 4. Silicon Dioxide/Ultrasil 7000 GR/ | 10 | 15 |
| 5. Carbon black N 550 | 5 | 5 |
| 6. 3-thiocyanato-propyl-triethoxy silane/Si- | 6 | 3 |
| 264/— | | |
| 7. Bis(triethoxy-silylpropyl)tetrasulfide (Si 69) | 0.1 | 3 |
| 8. Rapeseed oil | 15 | 30 |
| 9. Zinc oxide | 3 | 3 |
| 10. Stearic acid | 2 | 2 |
| 11. Polymerized trimethyl dihydro-quinoline/ | 1.5 | 1.5 |
| TMQ/ | | |
| 12. Dimethylbutyl-phenyl-p-phenylenediamine | 1.5 | 1.5 |
| (6PDD) | | |
| 13. Tertiary butyl-benzothiazolyl-sulfenamide/ | 1 | 2 |
| TBBS/-accelerator | | |
| 14. Diphenylguanidine | 0.3 | 0.8 |
| 15. Phenyl-trichloromethylsulfenyl-benzene- | 0.1 | 0.5 |
| sulfonamide/Vulkalent E/C/ | | |
| 16. Sulfur | 1 | 2 |

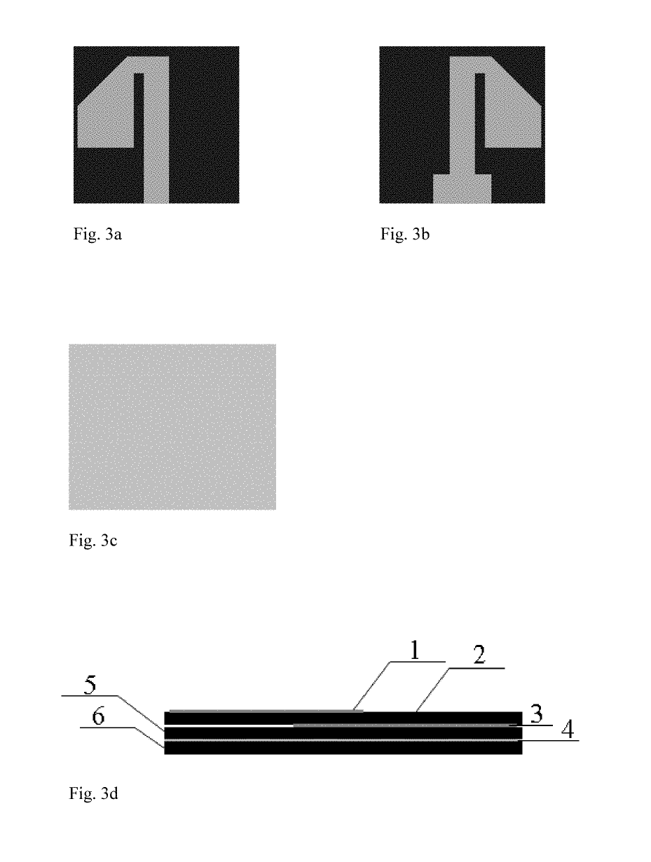

FIG. 3a, FIG. 3b, FIG. 3c, FIG. 3d visualize the configuration of an antenna whose metal elements are embedded in the elastomer composition shown in Example 2.

The antenna is made up of three components—a multilayer flexible elastomer pad, a modified version of a planar dipole antenna (emitter) and a rectangular reflector. The elastomer layers are composed of a MCC-2 elastomer composition with a thickness of 1.5 mm and electromagnetic parameters (real part of the permittivity (ε′ᵣ)—2.99, imaginary part of the permittivity (ε″ᵣ)—0.11, conductivity—(σ)—0.015). The electromagnetic parameters of the rubber-based synthesis composition are determined by the small interference method at frequency of 2.56 GHz. The reason for using a pad having the composition according to the present invention is due to the fact that it exhibit a good balance of mechanical (high flexibility, ability to withstand mechanical stresses) properties and electromagnetic parameters (low change with regard to ε_{↓}r^{↑},ε_{↓}r^{↑}″ [symbol] ( ₎ over a wide frequency range. The conductive components of the antenna are made of 0.05 mm thick brass sheet film with regard to the radiating elements and 0.011 mm thick aluminum foil with regard to the reflector. Between layer 2 and layer 3 of the elastomer composition, a reflector is provided, as shown in FIG. 3d to reduce SAR values affecting human tissues when the antenna is placed in close vicinity to the human body.

1. An elastomer composition for embedding a compact antenna, comprising:
natural rubber, the elastomer composition is multilayer and the components of the composition whose weights are expressed in parts per hundred parts of rubber by weight of natural rubber consisting essentially of:
sulfur—1 to 2 phr;
phenyl-trichloromethyl-sulfenyl-benzenesulfonamide—0.1 to 0.5 phr;
diphenylguanidine—0.3 to 0.8 phr;
tertiary butyl-benzothiazolyl-sulfenamide—from 1 to 2 phr;
dimethylbutyl-phenyl-p-phenylenediamine—1.5 phr;
polymerized trimethyl dihydro-quinoline—1.5 phr;
stearic acid—2.0 phr;
zinc oxide—3.0 phr;
rapeseed oil—15 to 30 phr;
bis (triethoxysilylpropyl) tetrasulfide-silane—from 0.1 to 4.0 phr;
3-thiocyanato-propyl-triethoxy silane—from 2.0 to 6.0 phr;
carbon black—5.0 phr;
microcrystalline cellulose—from 20.0 phr to 60.0 phr; and
optionally silicon dioxide—from 10 to 50.0 phr.

2. The elastomer composition intended for embedding a compact antenna according to claim 1, wherein the silicon dioxide is synthetic or rice husks based and is contained in the following amounts: synthetic silicon ranging from 10 to 50 or rice husk based silicon ranging from 10 to 50 or 10-5% or a mixture thereof in a ratio ranging from 1:5 to 5:1.

3. The elastomer composition intended for embedding a compact antenna according to claim 1, wherein the elastomer composition comprises 2 or 3 layers.

4. An elastomer composition for embedding a compact antenna, comprising:
natural rubber, the elastomer composition is multilayer and the components of the composition consisting essentially of:
sulfur;
phenyl-trichloromethyl-sulfenyl-benzenesulfonamide;
diphenylguanidine;
tertiary butyl-benzothiazolyl-sulfenamide;
dimethylbutyl-phenyl-p-phenylenediamine;
polymerized trimethyl dihydro-quinoline;
stearic acid;
zinc oxide;
rapeseed oil;
bis (triethoxysilylpropyl) tetrasulfide-silane;
3-thiocyanato-propyl-triethoxy silane;
carbon black; and
microcrystalline cellulose.
